(19) United States
(12) Patent Application Publication
(10) Pub. No.: US 2026/0172074 A1
(43) Pub. Date: Jun. 18, 2026

(54) RECONFIGURABLE INTELLIGENT SURFACE (RIS) CIRCUIT IN A WIRELESS COMMUNICATIONS SYSTEM (WCS)

(71) Applicant: CORNING RESEARCH & DEVELOPMENT CORPORATION, Corning, NY (US)

(72) Inventors: Hyeng-cheul Choi, Seoul (KR); Jae-won Huh, Asan-city (KR); Boyoung Kang, Asan-si (KR); Byounggwan Kang, Painted Post, NY (US); Changhyeong Lee, Asan-si (KR)

(21) Appl. No.: 19/530,725

(22) Filed: Feb. 5, 2026

Related U.S. Application Data
(63) Continuation of application No. PCT/US2024/041454, filed on Aug. 8, 2024.
(60) Provisional application No. 63/533,985, filed on Aug. 22, 2023.

(51) Int. Cl. H04B 7/04

(52) U.S. Cl. CPC H04B 7/04013

(57) ABSTRACT

A reconfigurable intelligent surface (RIS) circuit in a wireless communications system (WCS) is disclosed. The WCS can be a fifth generation (5G), or a sixth generation (6G) wireless system configured to communicate in a radio spectrum highly susceptible to propagation and/or reflection loss caused by obstructors in the propagation path. Herein, the RIS circuit can be configured to absorb an incoming electromagnetic wave and reflect the incoming electromagnetic wave in a desired outgoing direction to help overcome the propagation and/or reflection loss. In an embodiment, elevation angles of the incoming and outgoing electromagnetic waves are restricted, while azimuth angles of the incoming and outgoing electromagnetic waves can be reconfigured by controllers to steer the outgoing electromagnetic wave toward a desired outgoing direction. Hence, it is possible to reduce the number of controllers required for controlling the elevation angles, thus helping to substantially reduce cost and complexity of the RIS circuit.

### CROSS-REFERENCE TO RELATED APPLICATION

This application is a continuation of Internation Patent Application No. PCT/US2024/041454, filed on Aug. 8, 2024, which claims the benefit of priority of U.S. Provisional Application No. 63/533,985, filed on Aug. 22, 2023, the content of which is relied upon and incorporated herein by reference in its entirety.

### BACKGROUND

The disclosure relates generally to an active reconfigurable intelligent surface (RIS) circuit in a wireless communications system (WCS), which can include a fifth generation (5G) system, a 5G new-radio (5G-NR) system, and/or a distributed communications system (DCS).

Wireless communication is rapidly growing, with ever-increasing demands for high-speed mobile data communication. As an example, local area wireless services (e.g., so-called “Wi-Fi” systems) and wide area wireless services are being deployed in many different types of areas (e.g., coffee shops, airports, libraries, etc.). Communications systems have been provided to transmit and/or distribute communications signals to wireless nodes called “clients,” “client devices,” or “wireless client devices,” which must reside within the wireless range or “cell coverage area” in order to communicate with an access point device. Example applications where communications systems can be used to provide or enhance coverage for wireless services include public safety, cellular telephony, wireless local access networks (LANs), location tracking, and medical telemetry inside buildings and over campuses. One approach to deploying a communications system involves the use of radio nodes/base stations that transmit communications signals distributed over physical communications medium remote units forming RF antenna coverage areas, also referred to as “antenna coverage areas.” The remote units each contain or are configured to couple to one or more antennas configured to support the desired frequency(ies) of the radio nodes to provide the antenna coverage areas. Antenna coverage areas can have a radius in a range from a few meters up to twenty meters, as an example. Another example of a communications system includes radio nodes, such as base stations, that form cell radio access networks, wherein the radio nodes are configured to transmit communications signals wirelessly directly to client devices without being distributed through intermediate remote units.

For example, FIG. 1 is an example of a WCS 100 that includes a radio node 102 configured to support one or more service providers 104(1)-104(N) as signal sources (also known as “carriers” or “service operators”—e.g., mobile network operators (MNOs)) and wireless client devices 106(1)-106(W). For example, the radio node 102 may be a base station (eNodeB) that includes modem functionality and is configured to distribute communications signal streams 108(1)-108(S) to the wireless client devices 106(1)-106(W) based on communications signals 110(1)-110(N) received from the service providers 104(1)-104(N). The communications signal streams 108(1)-108(S) of each respective service provider 104(1)-104(N) in their different spectrums are radiated through an antenna 112 to the wireless client devices 106(1)-106(W) in a communication range of the antenna 112. For example, the antenna 112 may be an antenna array. As another example, the radio node 102 in the WCS 100 in FIG. 1 can be a small cell radio access node (“small cell”) that is configured to support the multiple service providers 104(1)-104(N) by distributing the communications signal streams 108(1)-108(S) for the multiple service providers 104(1)-104(N) based on respective communications signals 110(1)-110(N) received from a respective evolved packet core (EPC) network CN₁-CN_{N} of the service providers 104(1)-104(N) through interface connections. The radio node 102 includes radio circuits 118(1)-118(N) for each service provider 104(1)-104(N) that are configured to create multiple simultaneous RF beams (“beams”) 120(1)-120(N) for the communications signal streams 108(1)-108(S) to serve multiple wireless client devices 106(1)-106(W). For example, the multiple RF beams 120(1)-120(N) may support multiple-input, multiple-output (MIMO) communications.

The radio node 102 of the WCS 100 in FIG. 1 may be configured to support service providers 104(1)-104(N) that have a different frequency spectrum and do not share the spectrum. Thus, in this instance, the communications signals 110(1)-110(N) from the different service providers 104(1)-104(N) do not interfere with each other even if transmitted by the radio node 102 at the same time. The radio node 102 may also be configured as a shared spectrum communications system where the multiple service providers 104(1)-104(N) have a shared spectrum. In this regard, the capacity supported by the radio node 102 for the shared spectrum is split (i.e., shared) between the multiple service providers 104(1)-104(N) for providing services to the subscribers.

The radio node 102 in FIG. 1 can also be coupled to a distributed communications system (DCS), such as a distributed antenna system (DAS), such that the radio circuits 118(1)-118(N) remotely distribute the communications signals 110(1)-110(N) of the multiple service providers 104(1)-104(N) to remote units. The remote units can each include an antenna array that includes tens or even hundreds of antennas for concurrently radiating the communications signals 110(1)-110(N) to subscribers using spatial multiplexing. Herein, the spatial multiplexing is a scheme that takes advantage of the differences in RF channels between transmitting and receiving antennas to provide multiple independent streams between the transmitting and receiving antennas, thus increasing throughput by sending data over parallel streams. Accordingly, the remote units can be said to radiate the communications signals 110(1)-110(N) to subscribers based on a massive multiple-input multiple-output (M-MIMO) scheme.

The WCS 100 may be configured to operate as a 5G and/or a 5G-NR communications system. In this regard, the radio node 102 can function as a 5G or 5G-NR base station (a.k.a. eNodeB) to service the wireless client devices 106(1)-106(W) in, for example, a small cell. Notably, the 5G or 5G-NR wireless communications system may be implemented based on a millimeter-wave (mmWave) spectrum (30 to 300 GHz) that can make the communications signals 110(1)-110(N) more susceptible to propagation loss and/or interference. Moreover, the RF beams 120(1)-120(N) may be blocked and/or reflected by obstructors (e.g., trees, walls, etc.) to cause substantial propagation and/or reflection loss. As a result, the link budget of the communications signals 110(1)-110(N) may be severely degraded.

Many convention solutions, such as high gain phased array antenna and repeaters, have been developed to help mitigate the link budget degradation resulted from propagation and/or reflection loss. However, each of these conventional solutions has notable shortcomings. Taking high gain phased array antenna as an example, a gain of the phased array antenna can be saturated by a feeding network in a base station or reduced due to space constraint in a mobile device. The use of repeaters, on the other hand, can significantly increase the costs of the WCS. As such, it is desirable to overcome the propagation and/or reflection loss with low cost and low complexity solutions.

### SUMMARY

Embodiments disclosed herein include a reconfigurable intelligent surface (RIS) circuit in a wireless communications system (WCS). In an embodiment, the WCS can be a fifth generation (5G), or a sixth generation (6G) wireless system configured to communicate in a radio spectrum (e.g., >30 GHz) highly susceptible to propagation and/or reflection loss caused by obstructors in the propagation path. In this regard, a reconfigurable intelligent surface (RIS) can be provided around the obstructors to redirect a blocked electromagnetic wave(s) toward a desired direction. Conventionally, an RIS typically includes an array of unit cells (e.g., N×N unit cells) that are controlled by an array of controllers (N×N controllers) to steer the blocked electromagnetic wave(s) toward the desired direction associated with any elevation and azimuth angles. However, the excess number of required controllers can significantly increase cost and complexity of the RIS, especially when the number of unit cells in the RIS grows exponentially (e.g., from 8×8 to 64×64 or 128×128) in size.

In this regard, an RIS circuit can be configured according to embodiments of the present disclosure to reduce the number of controllers to reduce cost and complexity of the conventional RIS. Herein, the RIS circuit is configured to absorb an incoming electromagnetic wave and reflect the incoming electromagnetic wave in a desired outgoing direction. In an embodiment, elevation angles of the incoming and outgoing electromagnetic waves are restricted based on predefined user and/or configuration scenarios, while azimuth angles of the incoming and outgoing electromagnetic waves can be reconfigured by controllers to steer the outgoing electromagnetic wave toward a desired outgoing direction. By restricting the elevation angles of the incoming and outgoing electromagnetic waves, it is possible to reduce the number of controllers required for controlling the elevation angles, thus helping to substantially reduce cost and complexity of the RIS circuit.

One exemplary embodiment of the disclosure relates to an RIS circuit. The RIS circuit includes an RIS array. The RIS array is configured to absorb an incoming electromagnetic wave radiated from a radio node and reradiate an outgoing electromagnetic wave toward a user equipment (UE). The RIS array includes a plurality of unit cell column circuits. Each of the plurality of unit cell column circuits includes a plurality of vertical unit cells. Each of the plurality of vertical unit cells includes a respective one of plurality of non-uniform patches having different geometric dimensions predetermined to cause a uniform phase differential between each adjacent pair of the plurality of vertical unit cells. The RIS array also includes a plurality of unit cell row circuits. Each of the plurality of unit cell row circuits includes a plurality of horizontal unit cells. Each of the plurality of horizontal unit cells in a respective one of the plurality of unit cell row circuits includes a respective one of a plurality of uniform patches of an identical geometric dimension. The RIS array also includes a plurality of control lines. Each of the plurality of control lines is coupled to the plurality of non-uniform patches in a respective one of the plurality of unit cell column circuits.

An additional exemplary embodiment of the disclosure relates to a method for configuring an RIS circuit in a WCS. The method includes configuring an RIS array to absorb an incoming electromagnetic wave radiated from a radio node and reradiate an outgoing electromagnetic wave toward a UE. The method also includes configuring a plurality of unit cell column circuits in the RIS array to each include a plurality of vertical unit cells. Each of the plurality of vertical unit cells comprises a respective one of a plurality of non-uniform patches having different geometric dimensions predetermined to cause a uniform phase differential between each adjacent pair of the plurality of vertical unit cells. The method also includes configuring a plurality of unit cell row circuits in the RIS array to each comprise a plurality of horizontal unit cells. Each of the plurality of horizontal unit cells in a respective one of the plurality of unit cell row circuits comprises a respective one of a plurality of uniform patches of an identical geometric dimension. The method also includes providing a plurality of control lines in the RIS array each coupled to the plurality of non-uniform patches in a respective one of the plurality of unit cell column circuits.

An additional exemplary embodiment of the disclosure relates to a WCS. The WCS includes a distribution unit. The distribution unit is configured to distribute a plurality of data signals. The WCS also includes at least one radio node coupled to the distribution unit and configured to communicate with at least one UE in a respective coverage area. The WCS also includes at least one RIS circuit. The at least one RIS circuit is provided in the respective coverage area. The at least one RIS circuit comprises an RIS array. The RIS array is configured to absorb an incoming electromagnetic wave radiated from the at least one radio node and reflect an outgoing electromagnetic wave toward the at least one UE. The RIS array includes a plurality of unit cell column circuits each comprising a plurality of vertical unit cells. Each of the plurality of vertical unit cells comprises a respective one of plurality of non-uniform patches having different geometric dimensions predetermined to cause a uniform phase differential between each adjacent pair of the plurality of vertical unit cells. The RIS array also includes a plurality of unit cell row circuits each comprising a plurality of horizontal unit cells. Each of the plurality of horizontal unit cells in a respective one of the plurality of unit cell row circuits comprises a respective one of a plurality of uniform patches of an identical geometric dimension. The RIS array also includes a plurality of control lines. Each of the plurality of control lines is coupled to the plurality of non-uniform patches in a respective one of the plurality of unit cell column circuits.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic diagram of an exemplary wireless communications system (WCS), such as a distributed communications system (DCS), configured to distribute communications services to remote coverage areas;

FIGS. 2A-2D are schematic diagrams providing exemplary illustrations as to how a conventional active reconfigurable intelligent surface (RIS) operates in a radio frequency (RF) beamforming system;

FIG. 3 is a schematic diagram of an exemplary WCS that can be configured to support low cost and low complexity RIS according to various embodiments of the present disclosure;

FIG. 4 is a schematic diagram of an exemplary RIS circuit, which can be provided in the WCS of FIG. 3 and configured according to an embodiment of the present disclosure to enable low-cost and low-complexity RIS configuration;

FIG. 5 is a schematic diagram providing an exemplary sideview of the RIS circuit in FIG. 4;

FIG. 6 is a flowchart of an exemplary process for configuring the RIS circuit of FIG. 4 in the WCS of FIG. 3;

FIG. 7 is a partial schematic cut-away diagram of an exemplary building infrastructure in a WCS, such as the WCS of FIG. 3 that includes the RIS circuit of FIG. 4 to enable low-cost and low-complexity RIS configuration;

FIG. 8 is a schematic diagram of an exemplary mobile telecommunications environment that can include the WCS of FIG. 3 that includes the RIS circuit of FIG. 4 to enable low-cost and low-complexity RIS configuration; and

FIG. 9 is a schematic diagram of a representation of an exemplary computer system that can be included in or interfaced with any of the components in the WCS of FIG. 3 and the RIS circuit of FIG. 4 to enable low-cost and low-complexity RIS configuration, wherein the exemplary computer system is configured to execute instructions from an exemplary computer-readable medium.

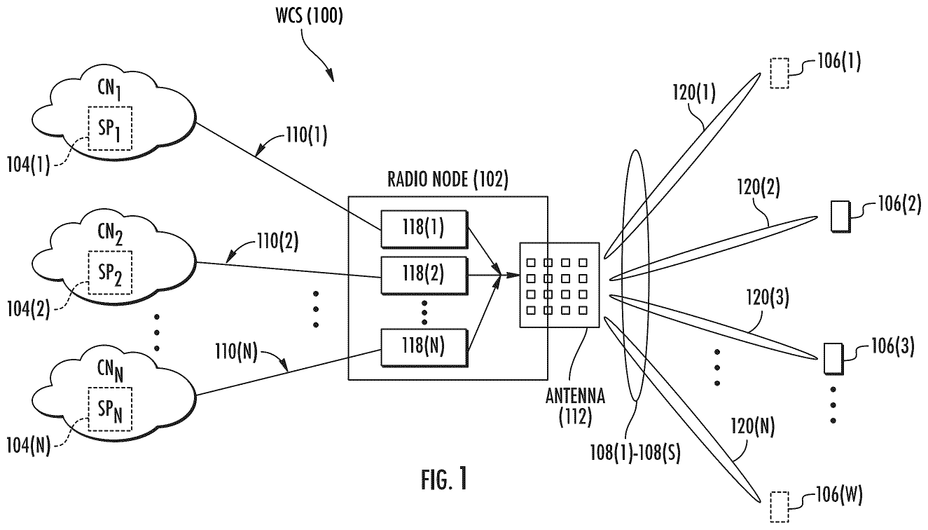

### DETAILED DESCRIPTION

Embodiments disclosed herein include a reconfigurable intelligent surface (RIS) circuit in a wireless communications system (WCS). In an embodiment, the WCS can be a fifth generation (5G), or a sixth generation (6G) wireless system configured to communicate in a radio spectrum (e.g., >30 GHz) highly susceptible to propagation and/or reflection loss caused by obstructors in the propagation path. In this regard, a reconfigurable intelligent surface (RIS) can be provided around the obstructors to redirect a blocked electromagnetic wave(s) toward a desired direction. Conventionally, an RIS typically includes an array of unit cells (e.g., N×N unit cells) that are controlled by an array of controllers (N×N controllers) to steer the blocked electromagnetic wave(s) toward the desired direction associated with any elevation and azimuth angles. However, the excess number of required controllers can significantly increase cost and complexity of the RIS, especially when the number of unit cells in the RIS grows exponentially (e.g., from 8×8 to 64×64 or 128×128) in size.

In this regard, an RIS circuit can be configured according to embodiments of the present disclosure to reduce the number of controllers to reduce cost and complexity of the conventional RIS. Herein, the RIS circuit is configured to absorb an incoming electromagnetic wave and reflect the incoming electromagnetic wave in a desired outgoing direction. In an embodiment, elevation angles of the incoming and outgoing electromagnetic waves are restricted based on predefined user and/or configuration scenarios, while azimuth angles of the incoming and outgoing electromagnetic waves can be reconfigured by controllers to steer the outgoing electromagnetic wave toward a desired outgoing direction. By restricting the elevation angles of the incoming and outgoing electromagnetic waves, it is possible to reduce the number of controllers required for controlling the elevation angles, thus helping to substantially reduce cost and complexity of the RIS circuit.

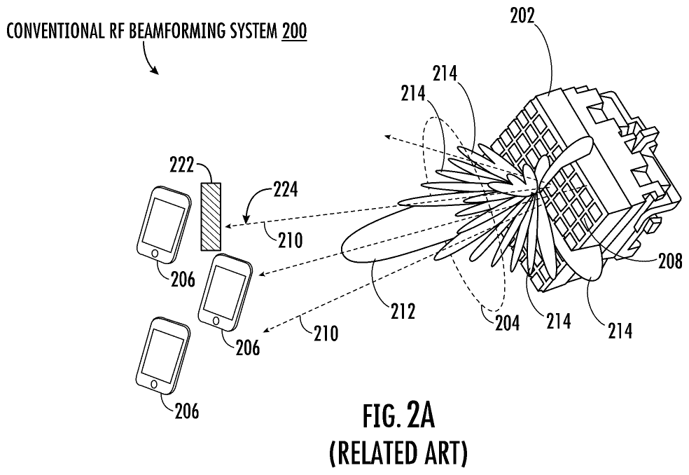

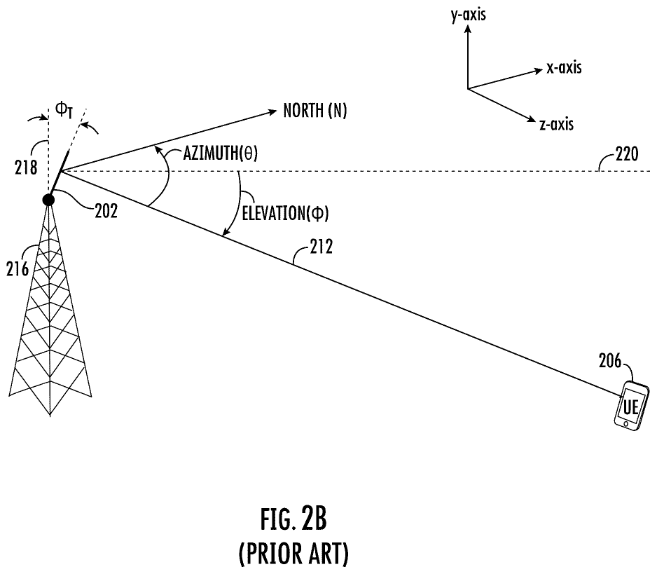

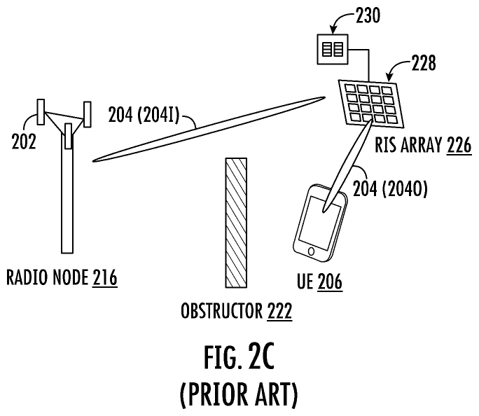

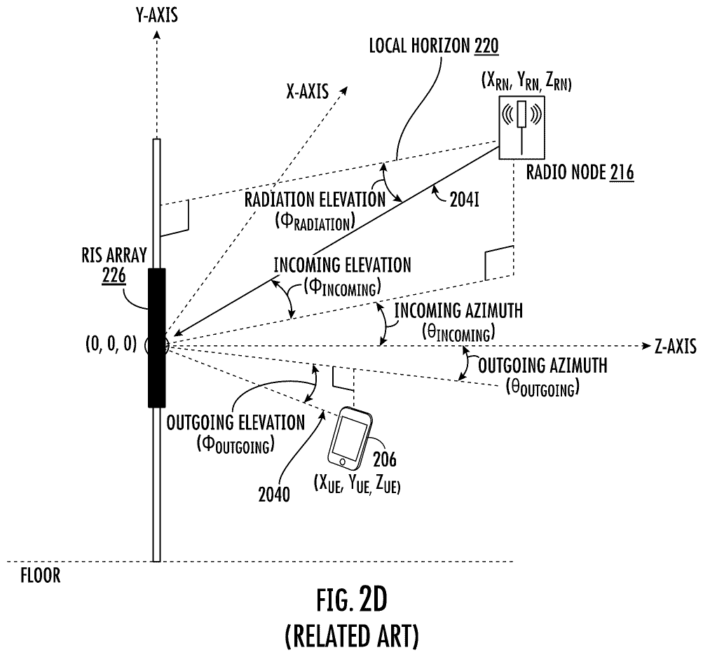

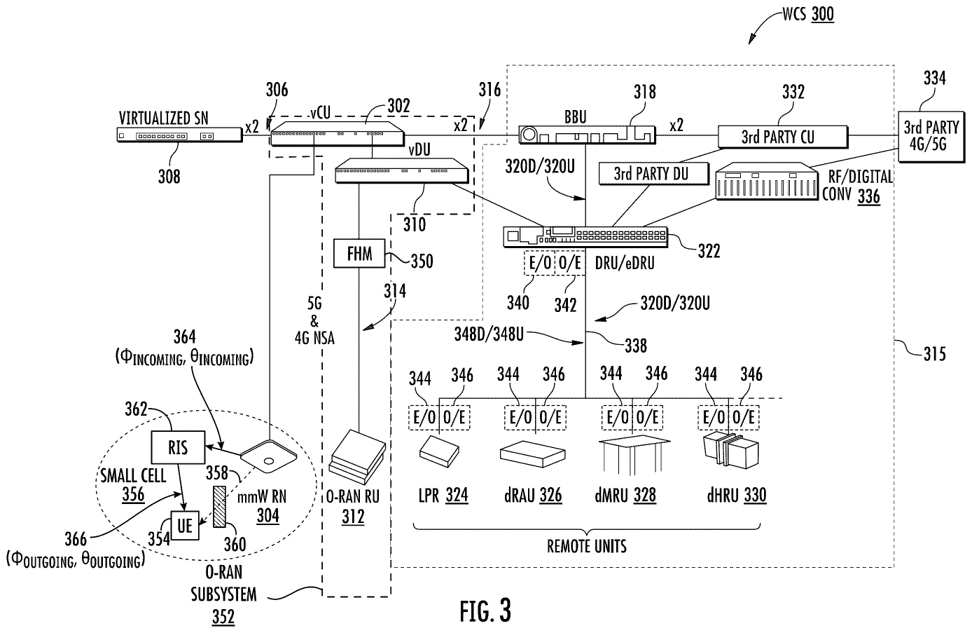

Before discussing a low-cost and low-complexity RIS circuit of the present disclosure, starting at FIG. 3, a brief overview of a conventional beamforming system is first provided with reference to FIGS. 2A-2D to help explain some fundamental aspects related to conventional RF beamforming and RIS and define some key terminologies used throughout the present disclosure. Common elements between FIGS. 2A-2D are shown therein with common element numbers and will not be re-described herein.

FIG. 2A is a schematic diagram of an RF beamforming system 200 wherein an antenna array 202 emits an RF beam(s) 204 toward one or more user devices 206. The antenna array 202 includes multiple antenna elements 208 that are typically separated from each other by a distance (a.k.a. “antenna spacing”). The RF beam(s) 204 emitted from the antenna elements 208 includes multiple beamforming signals (not shown). The beamforming signals are preprocessed based on a set of complex-valued coefficients, which is commonly known as a beamforming codeword, and/or further processed to provide phase and/or amplitude changes as needed. Specifically, multiplication of the beamforming codeword is realized by a combination of digital processing and through phase and/or amplitude control applied at an input of the antenna elements 208 to thereby maximize an array gain in a desired beam direction(s) 210. By applying the set of complex-valued coefficients to the beamforming signals, the multiple simultaneously emitted beamforming signals can form the RF beam(s) 204, which may be multiple RF beams each described by gain, intensity, power, and/or electric/magnetic field values versus elevation and azimuth directions. In this regard, it can be said that the RF beam(s) 204 is associated with, or defined by, a respective beamforming codeword. Accordingly, a list of different beamforming codewords, often referred to as a beamforming codebook, can define multiple different RF beams.

Notably, the RF beam(s) 204 often includes a main lobe 212, where radiated power is concentrated and close to a maximum radiated power, and one or more sidelobes 214 with lesser amounts of radiated power. Typically, a radiation direction of the main lobe 212 determines the desired beam direction(s) 210 of the RF beam(s) 204, and a beamwidth of the RF beam(s) 204 is defined by a set of the radiation directions 210 wherein the radiated power is not lower than 3 dB from the maximum radiated power.

Conventionally, the desired direction(s) 210 can be described by a combination of an elevation angle (a.k.a. “elevation”) and an azimuth angle (a.k.a. “azimuth”). FIG. 2B is a schematic diagram illustrating the elevation angle φ and the azimuth angle θ that can be used to describe the desired beam direction(s) 210 in the RF beamforming system 200 of FIG. 2A. Herein, the antenna array 202 may be mounted on a radio node 216 with a tilt angle φ_{T} relative to a vertical axis 218 perpendicular to a local horizon 220. The elevation angle φ of the main lobe 212, which defines the desired beam direction(s) 210, refers to a vertical angular distance between the antenna array 202 and the local horizon 220. The azimuth angle θ refers to an angular distance in the x-z plane, measured clockwise from the z-axis to the x-axis.

With reference back to FIG. 2A, the RF beam(s) 204 may be blocked or reflected by an obstructor 222 (e.g., a tree or a wall) in a propagation path 224 to therefore change the desired direction(s) 210. Moreover, the obstructor 222 can severely degrade the link budget of the propagation path 224 due to propagation and/or reflection losses. As such, as shown in FIG. 2C, an RIS array 226 may be provided around the obstructor 222 to redirect the otherwise blocked RF beam(s) 204 toward the user devices 206. For distinction, the RF beam(s) 204 received by the RIS array 226 is referred to interchangeably as an incoming electromagnetic wave 204I and the redirected RF beam(s) 204 is referred to interchangeably as an outgoing electromagnetic wave 204O.

FIG. 2D is a schematic diagram providing an exemplary illustration as to how the RIS array 226 in FIG. 2C can be configured to absorb the incoming electromagnetic wave 204I and reradiate the outgoing electromagnetic wave 204O by redirecting the incoming electromagnetic wave 204I. Herein, the radio node 216 is provided at a location described by a set of coordinates (X_{RN}, Y_{RN}, Z_{RN}), the wireless device 206 is located at a location described by another set of coordinates (X_{UE}, Y_{UE}, Z_{UE}), and the RIS array 226 is located at a coordinate origin (0, 0, 0).

The incoming electromagnetic wave 204I radiated from the radio node 216 toward the RIS array 226 has a radiation elevation angle φ_{RADIATION} relative to the local horizon of the radio node 216. The incoming electromagnetic wave 204I as absorbed by the RIS array 226 is defined by an incoming elevation angle φ_{INCOMING} and an incoming azimuth angle θ_{INCOMING}. The outgoing electromagnetic wave 204O as reflected by the RIS array 226 is defined by an outgoing elevation angle φ_{OUTGOING} and an outgoing azimuth angle θ_{OUTGOING}. The incoming elevation angle φ_{INCOMING} and the outgoing elevation angle φ_{OUTGOING} can be determined as in equation (Eq. 1 and Eq. 2) below.

$${ϕ}_{INCOMING} = {tan}^{- 1} \frac{{Y}_{RN}}{\sqrt{{X}_{RN}^{2} + {Z}_{RN}^{2}}} \qquad ( Eq . 1 )$$

$${ϕ}_{OUTGOING} = {tan}^{- 1} \frac{{Y}_{UE}}{\sqrt{{X}_{UE}^{2} + {Z}_{UE}^{2}}} \qquad ( Eq . 2 )$$

With reference back to FIG. 2C, the RIS array 226 is typically an N-row by N-column array that includes N×N unit cells 228. Each of the unit cells 228 will absorb the same incoming electromagnetic wave 204I with a different phase offset. In this regard, to steer the outgoing electromagnetic wave 204O toward the user devices 206, it is necessary to revise the phase of each of the unit cells 228 by taking into consideration a phase distribution of the incoming electromagnetic wave 204I. In addition, since the incoming elevation angle ØINCOMING of the incoming electromagnetic wave 204I can vary widely due to different vertical and horizontal distances between the radio node 216 and the RIS array 226, it is necessary to control both the outgoing azimuth angle θ_{OUTGOING} and the outgoing elevation angle φ_{OUTGOING}. Therefore, to cover all azimuth and elevation possibilities of the outgoing electromagnetic wave 204O, it will require a total of N×N controllers 230 to individually control the N×N unit cells 228.

Understandably, as the number of the unit cells 228 grows (e.g., from 8×8 to 64×64 or even more), the number of controllers 230 will grow accordingly. As a result, the cost and complexity for redirecting the RF beam(s) 204 toward the user devices 206 may increase substantially. It is thus desirable to employ a lower cost and lower complexity RIS configuration to help redirect the RF beam(s) 204 toward the user devices 206.

In this regard, FIG. 3 is a schematic diagram of an exemplary WCS 300 that can be configured according to various embodiments of the present disclosure to support a low-cost and low-complexity RIS configuration. The WCS 300 supports both legacy 4G LTE, 4G/5G non-standalone (NSA), and 5G standalone communications systems. As shown in FIG. 3, a centralized services node 302 is provided and is configured to interface with a core network to exchange communications data and distribute the communications data as radio signals to various wireless nodes. In this example, the centralized services node 302 is configured to support distributed communications services to a radio node (RN) 304 (e.g., 5G or 5G-NR gNB). Despite the fact that only one radio node 304 is shown in FIG. 3, it should be appreciated that the WCS 300 can be configured to include additional numbers of the radio node 304, as needed.

The functions of the centralized services node 302 can be virtualized through, for example, an x2 interface 306 to another services node 308. The centralized services node 302 can also include one or more internal radio nodes that are configured to be interfaced with a distribution unit (DU) 310 to distribute communications signals to one or more open radio access network (O-RAN) remote units (RUs) 312 that are configured to be communicatively coupled through an O-RAN interface 314. The O-RAN RUs 312 are each configured to communicate downlink and uplink communications signals in a respective coverage cell.

The centralized services node 302 can also be interfaced with a distributed communications system (DCS) 315 through an x2 interface 316. Specifically, the centralized services node 302 can be interfaced with a digital baseband unit (BBU) 318 that can provide a digital signal source to the centralized services node 302. The digital BBU 318 may be configured to provide a signal source to the centralized services node 302 to provide downlink communications signals 320D to a digital routing unit (DRU) 322 as part of a digital distributed antenna system (DAS). The DRU 322 is configured to split and distribute the downlink communications signals 320D to different types of remote units, including a low-power remote unit (LPR) 324, a radio antenna unit (dRAU) 326, a mid-power remote unit (dMRU) 328, and a high-power remote unit (dHRU) 330. The DRU 322 is also configured to combine uplink communications signals 320U received from the LPR 324, the dRAU 326, the dMRU 328, and the dHRU 330 and provide the combined uplink communications signals to the digital BBU 318. The digital BBU 318 is also configured to interface with a third-party central unit 332 and/or an analog source 334 through a radio frequency (RF)/digital converter 336.

The DRU 322 may be coupled to the LPR 324, the dRAU 326, the dMRU 328, and the dHRU 330 via an optical fiber-based communications medium 338. In this regard, the DRU 322 can include a respective electrical-to-optical (E/O) converter 340 and a respective optical-to-electrical (O/E) converter 342. Likewise, each of the LPR 324, the dRAU 326, the dMRU 328, and the dHRU 330 can include a respective E/O converter 344 and a respective O/E converter 346.

The E/O converter 340 at the DRU 322 is configured to convert the downlink communications signals 320D into downlink optical communications signals 348D for distribution to the LPR 324, the dRAU 326, the dMRU 328, and the dHRU 330 via the optical fiber-based communications medium 338. The O/E converter 346 at each of the LPR 324, the dRAU 326, the dMRU 328, and the dHRU 330 is configured to convert the downlink optical communications signals 348D back to the downlink communications signals 320D. The E/O converter 344 at each of the LPR 324, the dRAU 326, the dMRU 328, and the dHRU 330 is configured to convert the uplink communications signals 320U into uplink optical communications signals 348U. The O/E converter 342 at the DRU 322 is configured to convert the uplink optical communications signals 348U back to the uplink communications signals 320U.

In context of the present disclosure, a wireless node refers generally to a wireless communication circuit including at least a processing circuit, a memory circuit, and an antenna circuit, and can be configured to process, transmit, and receive a wireless communications signal. In this regard, any of the radio node 304, the O-RAN RN 312, the LPR 324, the dRAU 326, the dMRU 328, and the dHRU 330 can function as a wireless node to reduce power consumption associated with RF beam sidelobe suppression based on embodiments disclosed herein. As described in detail below, the wireless node in the WCS 300 can include a beamforming system configured according to embodiments of the present disclosure to support simultaneous multi-data stream and multi-beam beamforming.

In an embodiment, the DU 310 can be coupled to the O-RAN RUs 312 via a front-haul multiplexer (FHM) 350. In this regard, the CU 302, the DU 310, the FHM 350, and the O-RAN RUs 312 collectively form an O-RAN subsystem 352 in the WCS 300. Accordingly, the O-RAN subsystem 352 can be configured to operate based on O-RAN shared-cell topology to support multiple RU clusters.

In an embodiment, the RN 304 may be configured to provide wireless communication service to at least one user equipment (UE) 354 in a small cell 356. A direct propagation path 358 between the UE 354 and the RN 304 may be blocked by an obstructor 360. Thus, at least one RIS circuit 362 is provided in the small cell 356 to absorb an incoming electromagnetic wave 364 from the RN 304 and redirect the absorbed incoming electromagnetic wave 364 toward the UE 354 as an outgoing electromagnetic wave 366.

Like the incoming electromagnetic wave 204I and the outgoing electromagnetic wave 204O in FIG. 2D, the incoming electromagnetic wave 364 is defined by an incoming elevation angle φ_{INCOMING} and an incoming azimuth angle θ_{INCOMING}, and the outgoing electromagnetic wave 366 is defined by an outgoing elevation angle ØOUTGOING and an outgoing azimuth angle θ_{OUTGOING}.

As discussed in detail below, the incoming elevation angle φ_{INCOMING} and the outgoing elevation angle ØOUTGOING are restricted based on predefined user and/or configuration scenarios in the WCS 300, while the incoming azimuth angle θ_{INCOMING} and the outgoing azimuth angle θ_{OUTGOING} are dynamically controlled to steer the outgoing electromagnetic wave 366 toward the UE 354. By restricting the incoming elevation angle φ_{INCOMING} and the outgoing elevation angle φOUTGOING, it is possible to reduce the number of controllers required for controlling the outgoing elevation angle φ_{OUTGOING} of the outgoing electromagnetic wave 366, thus helping to substantially reduce cost and complexity of the RIS circuit 362.

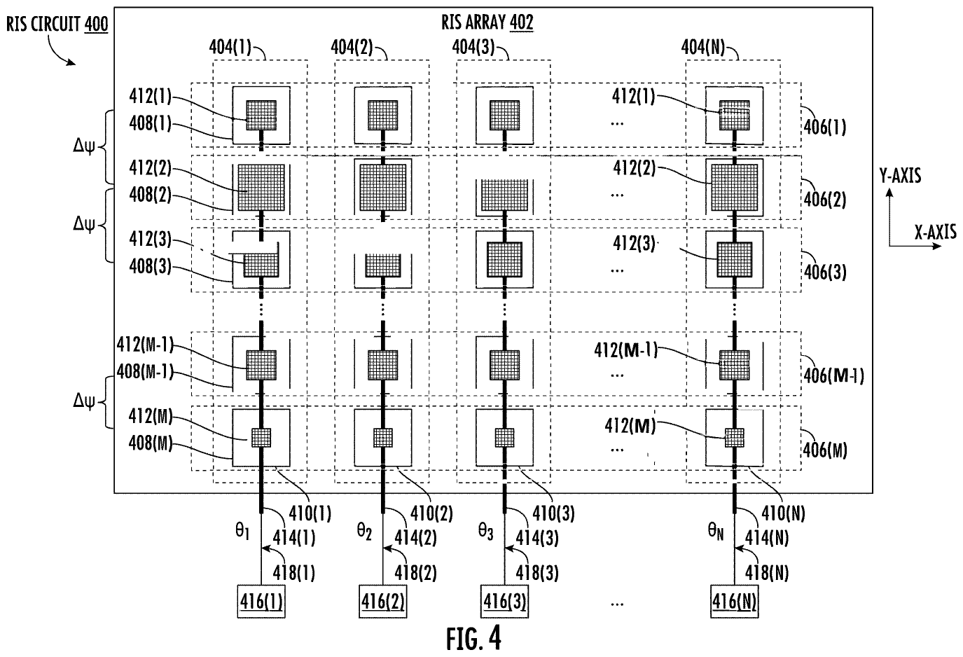

FIG. 4 is a schematic diagram of an exemplary RIS circuit 400, which is identical to the RIS circuit 362 in the WCS 300 of FIG. 3 and configured according to an embodiment of the present disclosure to enable low-cost and low-complexity RIS configuration. Elements in FIG. 3 are referenced herein in FIG. 4 with common element numbers and will not be re-described herein.

The RIS circuit 400 includes an RIS array 402, which is functionally equivalent to the RIS array 222 in FIG. 2C. The RIS array 402 can be provided in the RIS circuit 362 in FIG. 3 to absorb the incoming electromagnetic wave 364 radiated from the RN 304 and redirect the absorbed incoming electromagnetic wave 364 toward the UE 354 in the outgoing electromagnetic wave 366.

In an embodiment, the RIS array 402 includes a plurality of unit cell column circuits 404(1)-404(N) and a plurality of unit cell row circuits 406(1)-406(M). Each of the unit cell column circuits 404(1)-404(N) includes a plurality of vertical unit cells 408(1)-408(M). Each of the unit cell row circuits 406(1)-406(M) includes a plurality of horizontal unit cells 410(1)-410(N). In this regard, the RIS array 402 is an N×M array that includes a total of N×M vertical and horizontal unit cells. Each of the vertical unit cells 408(1)-408(M) and the horizontal unit cells 410(1)-410(N) has an identical geometric dimension. In a non-limiting example, each of the vertical unit cells 408(1)-408(M) and the horizontal unit cells 410(1)-410(N) is a square unit cell with an identical maximum area size.

Herein, each of the vertical unit cells 408(1)-408(M) in each of the unit cell column circuits 404(1)-404(N) is configured to include a respective one of a plurality of non-uniform patches 412(1)-412(M). In an embodiment, the non-uniform patches 412(1)-412(M) in a respective one of the unit cell column circuits 404(1)-404(N) are configured to have different geometric dimensions. In a non-limiting example, the non-uniform patches 412(1)-412(M) are square patches of different area sizes. More specifically, the respective area size of a respective one of the non-uniform patches 412(1)-412(M) is configured to be less than or equal to the maximum area size of the respective one of the vertical unit cells 408(1)-408(M).

Understandably, the different geometric dimensions can cause the non-uniform patches 412(1)-412(M) to exhibit different impedances (capacitive or inductive) and therefor cause different phase angles in the vertical unit cells 408(1)-408(M) in each of the unit cell column circuits 404(1)-404(N). In an embodiment, the different geometric dimensions of the non-uniform patches 412(1)-412(M) can be predetermined to cause a uniform phase differential ΔΨ_{Y-RIS} between each adjacent pair of the vertical unit cells 408(1)-408(M) in each of the unit cell column circuits 404(1)-404(N). Specifically, the different geometric dimensions of the non-uniform patches 412(1)-412(M) can be predetermined based on a restricted set of the incoming elevation angle ØINCOMING and the outgoing elevation angle ØOUTGOING that the RIS circuit 400 is configured to support. In an embodiment, the uniform phase differential ΔΨ_{Y-RIS} can be determined based on equation (Eq. 3) below.

$$Δ {Ψ}_{Y - RIS} = - ( 2 π / λ ) * p * sin ( {ϕ}_{OUTGOING} ) - ( 2 π / λ ) * p * sin ( {ϕ}_{INCOMING} ) \qquad ( Eq . 3 )$$

In the equation (Eq. 3), φ_{INCOMING} represents any of the restricted set of incoming elevation angles, φ_{OUTGOING} represents any of the restricted set of outgoing elevation angles, and p represents the maximum area of the vertical unit cells 408(1)-408(M) in each of the unit cell column circuits 404(1)-404(N). In a non-limiting example, if the incoming elevation angle φ_{INCOMING} and the outgoing elevation angle φ_{OUTGOING} are restricted to 75° and 5°, respectively, and p is set to be a quarter wavelength, the uniform phase differential ΔΨ_{Y-RIS} as calculated based on the equation (Eq. 3) will be approximately 80°. Accordingly, the respective phase angle, and thereby the respective geometric dimension, of each of the non-uniform patches 412(1)-412(M) can be determined to ensure the uniform phase differential ΔΨ_{Y-RIS} between each adjacent pair of the vertical unit cells 408(1)-408(M) in each of the unit cell column circuits 404(1)-404(N). In this regard, an elevation control aspect of the RIS circuit 400 can be predetermined (a.k.a. fixed) during, for example, an initial planning, installation, and/or calibration phase of the WCS 300. As such, it is not necessary to dynamically set the respective phase angle for each of the vertical unit cells 408(1)-408(M) in each of the unit cell column circuits 404(1)-404(N). As a result, it is possible to eliminate those controllers required for making elevation control to thereby reduce cost and complexity of the RIS circuit 400.

In an embodiment, an identically labeled non-uniform patch across the unit cell column circuits 404(1)-404(N) will have an identical geometric dimension. As an example, the same non-uniform patch 412(1) will have uniform geometric dimensions in all the unit cell column circuits 404(1)-404(N), the same non-uniform patch 412(2) will have uniform geometric dimensions in all the unit cell column circuits 404(1)-404(N), and so on. In other words, the unit cell column circuits 404(1)-404(N) will be identical in terms of how the non-uniform patches 412(1)-412(M) are arranged.

Accordingly, the horizontal unit cells 410(1)-410(N) will each include respective identically labeled non-uniform patches across the unit cell column circuits 404(1)-404(N). For example, the unit cell row circuit 406(1) includes the identically labeled non-uniform patch 412(1) across the unit cell column circuits 404(1)-404(N), the unit cell row circuit 406(2) includes the identically labeled non-uniform patch 412(2) across the unit cell column circuits 404(1)-404(N), and so on. In this regard, the respective non-uniform patches in each of the unit cell row circuits 406(1)-406(M) will have an identical geometric dimension and can be referred to as “uniform patches” for distinction.

The RIS array 402 also includes a plurality of control lines 414(1)-414(N), such as conduction metal traces, as an example. Each of the control lines 414(1)-414(N) is coupled to all the non-uniform patches 412(1)-412(M) in a respective one of the unit cell column circuits 404(1)-404(N).

In contrast to restricting the incoming elevation angle φ_{INCOMING} and the outgoing elevation angle φ_{OUTGOING}, it is possible to dynamically set each of the horizontal unit cells 410(1)-410(N) to a respective one of a plurality of phases θ₁-θ_{N} to thereby control the outgoing azimuth angle θ_{OUTGOING} of the outgoing electromagnetic wave 366. In an embodiment, the phase θᵢ∈(θ₁-θ_{N}) can be determined based on equation (Eq. 4) below.

$${θ}_{i} ∈ ( {θ}_{1} - {θ}_{N} ) = Δ {Ψ}_{Y - RIS} [ i ] + 360 k + β ) ( 1 \leq i \leq N ) \qquad ( Eq . 4 )$$

In the equation (Eq. 4), ΔΨ_{Y-RIS} [i] represents a respective uniform phase differential, k represents an integer value (0, 1, . . . ), and β represents a phase constant. In an embodiment, the RIS circuit 400 further includes a plurality of control circuits 416(1)-416(N). Each of the control circuits 416(1)-416(N) is coupled to a respective one of the control lines 414(1)-414(N) and configured to determine a respective one of the phases θ₁-θ_{N} to control the outgoing azimuth angle θ_{OUTGOING} of the outgoing electromagnetic wave 366. In an embodiment, each of the control circuits 416(1)-416(N) is configured to generate a respective one of a plurality of control signals 418(1)-418(N) to include a respective one of the phases θ₁-θ_{N} and provide the respective one of a plurality of control signals 418(1)-418(N) to a respective one of the control lines 414(1)-414(N). Each of the control lines 414(1)-414(N), in turn, relays the respective one of the control signals 418(1)-418(N) to all the non-uniform patches 412(1)-412(M) in a respective one of the unit cell column circuits 404(1)-404(N).

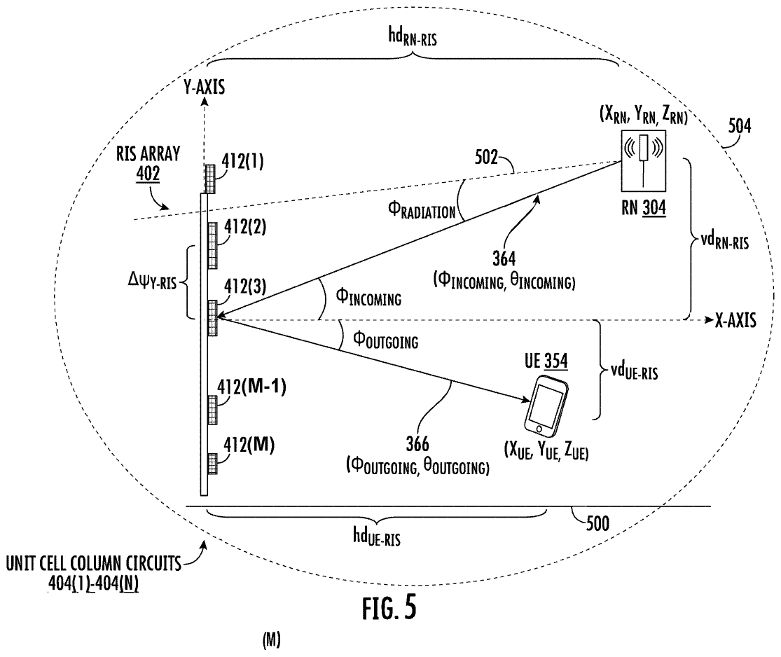

FIG. 5 is a schematic diagram providing an exemplary sideview of the RIS array 402 in FIG. 4. Common elements between FIGS. 3, 4, and 5 are shown therein with common element numbers and will not be re-described herein.

According to an embodiment of the present disclosure, the restricted set of the incoming elevation angles φ_{INCOMING} may be determined based on equation (Eq. 5) below.

$$( {ϕ}_{RADIATION} - \frac{1}{2} HPBW ) \leq {ϕ}_{INCOMING} \leq ( {ϕ}_{RADIATION} + \frac{1}{2} HPBW ) \qquad ( Eq . 5 )$$

In the equation (Eq. 5), φ_{RADIATION} represents an elevation angle of the incoming electromagnetic wave 364 relative to a local horizon 502 of the RN 304 and HPBW represents a half power beamwidth of the incoming electromagnetic wave 364. Specifically, the term (φ_{RADIATION}−½HPBW) defines a lower boundary for the incoming elevation angles φ_{INCOMING} and the term (φ_{RADIATION}+½HPBW) defines an upper boundary for the incoming elevation angles φ_{INCOMING}.

In an embodiment, the RIS array 402 may be provided in approximately a same height relative to a ground 500. Specifically, a vertical distance vd_{UE-RIS} between the RIS array 402 and the UE 354 should be less than or equal to a vertical distance vd_{RN-RIS} between the RIS array 402 and the RN 304 (vd_{UE-RIS}≤vd_{RN-RIS}). In addition, a horizontal distance hd_{RN-RIS} between the RIS array 402 and the RN 304 and a horizontal distance hd_{UE-RIS} between the RIS array 402 and the UE 354 should be less than or equal to a coverage radius defined by a coverage boundary 504.

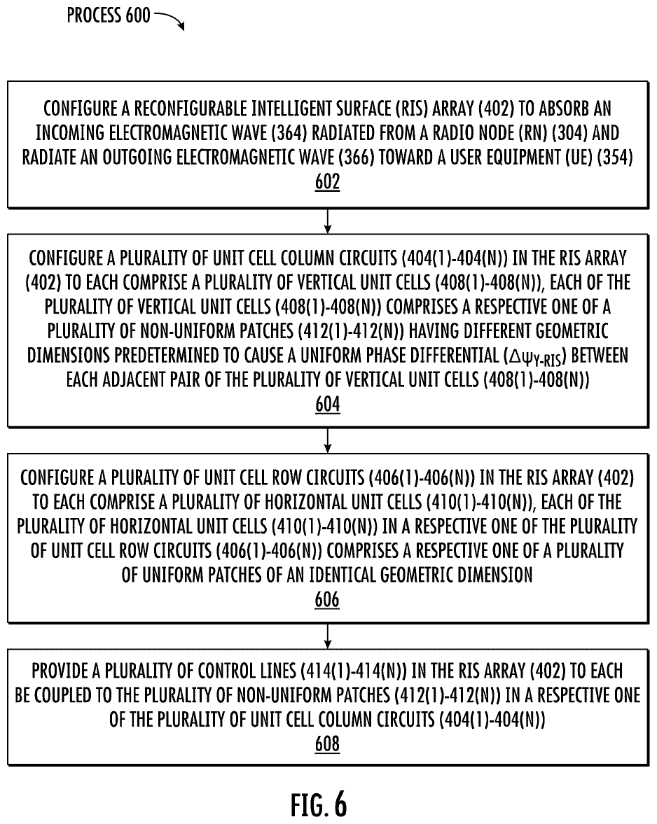

The low-cost, low-complexity RIS circuit 400 described herein can be configured in the WCS 300 of FIG. 3 according to a process. In this regard, FIG. 6 is a flowchart of an exemplary process 600 for configuring the RIS circuit 400 of FIG. 4 in the WCS 300 of FIG. 3.

Herein, the RIS array 402 is configured to absorb the incoming electromagnetic wave 364 radiated from the RN 304 and reradiate the outgoing electromagnetic wave 366 toward the UE 354 (block 602). The RIS array 402 is also configured to include the unit cell column circuits 404(1)-404(N) each including the vertical unit cells 408(1)-408(M). Each of the vertical unit cells 408(1)-408(M) includes a respective one of the non-uniform patches 412(1)-412(M) having different geometric dimensions predetermined to cause the uniform phase differential ΔΨ_{Y-RIS} between each adjacent pair of the vertical unit cells 408(1)-408(M) (block 604). The RIS array 402 is also configured to include the unit cell row circuits 406(1)-406(M) to each include the horizontal unit cells 410(1)-410(N). Each of the horizontal unit cells 410(1)-410(N) in a respective one of the unit cell row circuits 406(1)-406(M) includes a respective one of the uniform patches of an identical geometric dimension (block 606). The control lines 414(1)-414(N) are provided in the RIS array 402 to each be coupled to the non-uniform patches 412(1)-412(M) in a respective one of the unit cell column circuits 404(1)-404(N) (block 608).

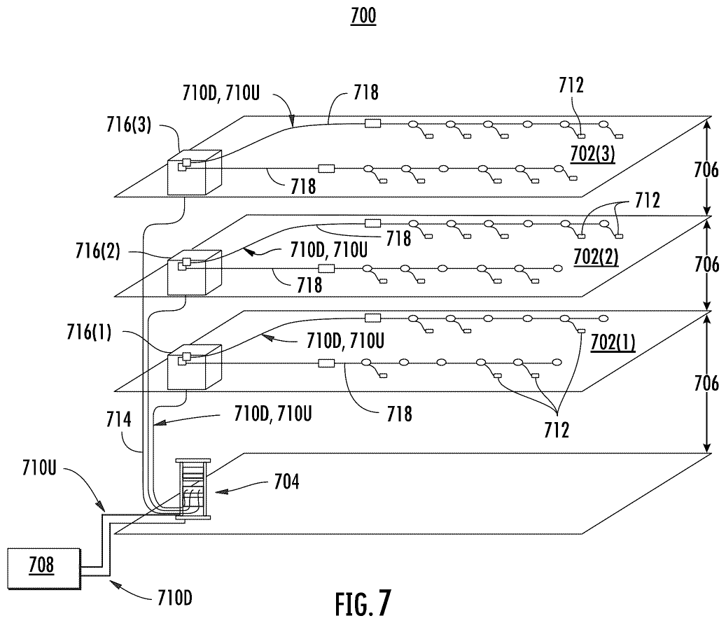

The WCS 300 of FIG. 3, which can include the RIS circuit 400 in FIG. 4, can be provided in an indoor environment as illustrated in FIG. 7. FIG. 7 is a partial schematic cut-away diagram of an exemplary building infrastructure 700 in a WCS, such as the WCS 300 of FIG. 3 that includes the RIS circuit 400 of FIG. 4 to enable low-cost and low-complexity RIS configuration. The building infrastructure 700 in this embodiment includes a first (ground) floor 702(1), a second floor 702(2), and a third floor 702(3). The floors 702(1)-702(3) are serviced by a central unit 704 to provide antenna coverage areas 706 in the building infrastructure 700. The central unit 704 is communicatively coupled to a base station 708 to receive downlink communications signals 710D from the base station 708. The central unit 704 is communicatively coupled to a plurality of remote units 712 to distribute the downlink communications signals 710D to the remote units 712 and to receive uplink communications signals 710U from the remote units 712, as previously discussed above. The downlink communications signals 710D and the uplink communications signals 710U communicated between the central unit 704 and the remote units 712 are carried over a riser cable 714. The riser cable 714 may be routed through interconnect units (ICUs) 716(1)-716(3) dedicated to each of the floors 702(1)-702(3) that route the downlink communications signals 710D and the uplink communications signals 710U to the remote units 712 and also provide power to the remote units 712 via array cables 718.

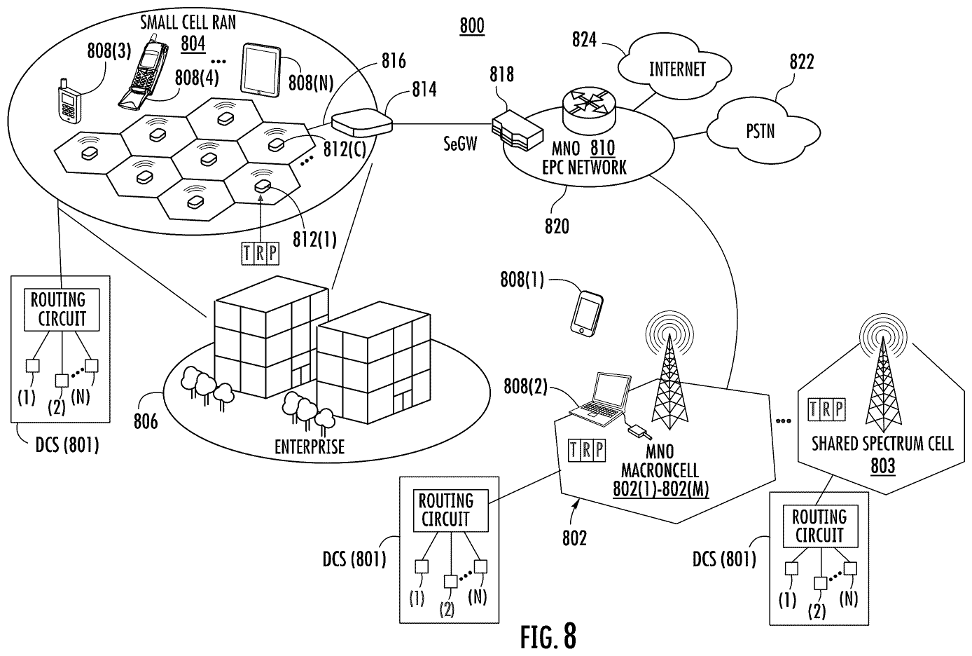

The WCS 300 of FIG. 3, which can include the RIS circuit 400 of FIG. 4, configured to enable low-cost and low-complexity RIS configuration, can also be interfaced with different types of radio nodes of service providers and/or supporting service providers, including macrocell systems, small cell systems, and remote radio heads (RRH) systems, as examples. For example, FIG. 8 is a schematic diagram of an exemplary mobile telecommunications environment 800 (also referred to as “environment 800”) that includes radio nodes and cells that may support shared spectrum, such as unlicensed spectrum, and can be interfaced to shared spectrum WCSs 801 supporting coordination of distribution of shared spectrum from multiple service providers to remote units to be distributed to subscriber devices. The shared spectrum WCSs 801 can include the WCS 300 of FIG. 3 that includes the RIS circuit 400 of FIG. 4, as an example.

The environment 800 includes exemplary macrocell RANs 802(1)-802(M) (“macrocells 802(1)-802(M)”) and an exemplary small cell RAN 804 located within an enterprise environment 806 and configured to service mobile communications between a user mobile communications device 808(1)-808(N) to a mobile network operator (MNO) 810. A serving RAN for the user mobile communications devices 808(1)-808(N) is a RAN or cell in the RAN in which the user mobile communications devices 808(1)-808(N) have an established communications session with the exchange of mobile communications signals for mobile communications. Thus, a serving RAN may also be referred to herein as a serving cell. For example, the user mobile communications devices 808(3)-808(N) in FIG. 8 are being serviced by the small cell RAN 804, whereas the user mobile communications devices 808(1) and 808(2) are being serviced by the macrocell 802. The macrocell 802 is an MNO macrocell in this example. However, a shared spectrum RAN 803 (also referred to as “shared spectrum cell 803”) includes a macrocell in this example and supports communications on frequencies that are not solely licensed to a particular MNO, such as CBRS for example, and thus may service user mobile communications devices 808(1)-808(N) independent of a particular MNO. For example, the shared spectrum cell 803 may be operated by a third party that is not an MNO and wherein the shared spectrum cell 803 supports CBRS. Also, as shown in FIG. 8, the MNO macrocell 802, the shared spectrum cell 803, and/or the small cell RAN 804 can interface with a shared spectrum WCS 801 supporting coordination of distribution of shared spectrum from multiple service providers to remote units to be distributed to subscriber devices. The MNO macrocell 802, the shared spectrum cell 803, and the small cell RAN 804 may be neighboring radio access systems to each other, meaning that some or all can be in proximity to each other such that a user mobile communications device 808(3)-808(N) may be able to be in communications range of two or more of the MNO macrocell 802, the shared spectrum cell 803, and the small cell RAN 804 depending on the location of the user mobile communications devices 808(3)-808(N).

In FIG. 8, the mobile telecommunications environment 800 in this example is arranged as an LTE system as described by the Third Generation Partnership Project (3GPP) as an evolution of the GSM/UMTS standards (Global System for Mobile communication/Universal Mobile Telecommunications System). It is emphasized, however, that the aspects described herein may also be applicable to other network types and protocols. The mobile telecommunications environment 800 includes the enterprise environment 806 in which the small cell RAN 804 is implemented. The small cell RAN 804 includes a plurality of small cell radio nodes 812(1)-812(C). Each small cell radio node 812(1)-812(C) has a radio coverage area (graphically depicted in the drawings as a hexagonal shape) that is commonly termed a “small cell.” A small cell may also be referred to as a femtocell or, using terminology defined by 3GPP, as a Home Evolved Node B (HeNB). In the description that follows, the term “cell” typically means the combination of a radio node and its radio coverage area unless otherwise indicated.

In FIG. 8, the small cell RAN 804 includes one or more services nodes (represented as a single services node 814) that manage and control the small cell radio nodes 812(1)-812(C). In alternative implementations, the management and control functionality may be incorporated into a radio node, distributed among nodes, or implemented remotely (i.e., using infrastructure external to the small cell RAN 804). The small cell radio nodes 812(1)-812(C) are coupled to the services node 814 over a direct or local area network (LAN) connection 816 as an example, typically using secure IPsec tunnels. The small cell radio nodes 812(1)-812(C) can include multi-operator radio nodes. The services node 814 aggregates voice and data traffic from the small cell radio nodes 812(1)-812(C) and provides connectivity over an IPsec tunnel to a security gateway (SeGW) 818 in a network 820 (e.g., evolved packet core (EPC) network in a 4G network, or 5G Core in a 5G network) of the MNO 810. The network 820 is typically configured to communicate with a public switched telephone network (PSTN) 822 to carry circuit-switched traffic, as well as for communicating with an external packet-switched network such as the Internet 824.

The environment 800 also generally includes a node (e.g., eNodeB or gNodeB) base station, or “macrocell” 802. The radio coverage area of the macrocell 802 is typically much larger than that of a small cell where the extent of coverage often depends on the base station configuration and surrounding geography. Thus, a given user mobile communications device 808(3)-808(N) may achieve connectivity to the network 820 (e.g., EPC network in a 4G network, or 5G Core in a 5G network) through either a macrocell 802 or small cell radio node 812(1)-812(C) in the small cell RAN 804 in the environment 800.

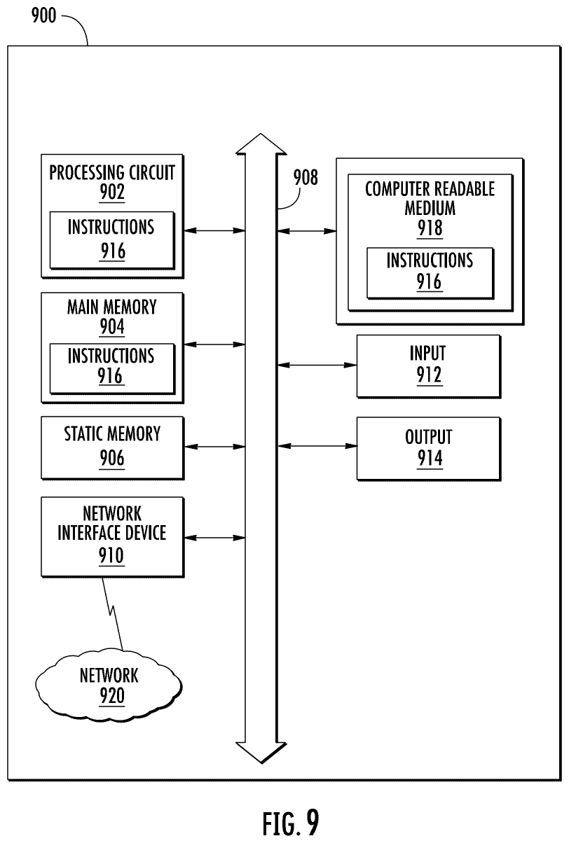

Any of the circuits in the WCS 300 of FIG. 3 and the RIS circuit 400 of FIG. 4, can include a computer system 900, such as that shown in FIG. 9, to carry out their functions and operations. With reference to FIG. 9, the computer system 900 includes a set of instructions for causing the multi-operator radio node component(s) to provide its designed functionality, and the circuits discussed above. The multi-operator radio node component(s) may be connected (e.g., networked) to other machines in a LAN, an intranet, an extranet, or the Internet. The multi-operator radio node component(s) may operate in a client-server network environment, or as a peer machine in a peer-to-peer (or distributed) network environment. While only a single device is illustrated, the term “device” shall also be taken to include any collection of devices that individually or jointly execute a set (or multiple sets) of instructions to perform any one or more of the methodologies discussed herein. The multi-operator radio node component(s) may be a circuit or circuits included in an electronic board card, such as a printed circuit board (PCB) as an example, a server, a personal computer, a desktop computer, a laptop computer, a personal digital assistant (PDA), a computing pad, a mobile device, or any other device, and may represent, for example, a server, edge computer, or a user's computer. The exemplary computer system 900 in this embodiment includes a processing circuit or processor 902, a main memory 904 (e.g., read-only memory (ROM), flash memory, dynamic random access memory (DRAM) such as synchronous DRAM (SDRAM), etc.), and a static memory 906 (e.g., flash memory, static random access memory (SRAM), etc.), which may communicate with each other via a data bus 908. Alternatively, the processing circuit 902 may be connected to the main memory 904 and/or static memory 906 directly or via some other connectivity means. The processing circuit 902 may be a controller, and the main memory 904 or static memory 906 may be any type of memory.

The processing circuit 902 represents one or more general-purpose processing circuits such as a microprocessor, central processing unit, or the like. More particularly, the processing circuit 902 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing circuit 902 is configured to execute processing logic in instructions 916 for performing the operations and steps discussed herein.

The computer system 900 may further include a network interface device 910. The computer system 900 also may or may not include an input 912 to receive input and selections to be communicated to the computer system 900 when executing instructions. The computer system 900 also may or may not include an output 914, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 900 may or may not include a data storage device that includes instructions 916 stored in a computer-readable medium 918. The instructions 916 may also reside, completely or at least partially, within the main memory 904 and/or within the processing circuit 902 during execution thereof by the computer system 900, the main memory 904 and the processing circuit 902 also constituting the computer-readable medium 918. The instructions 916 may further be transmitted or received over a network 920 via the network interface device 910.

While the computer-readable medium 918 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the processing circuit and that cause the processing circuit to perform any one or more of the methodologies of the embodiments disclosed herein. The term “computer-readable medium” shall accordingly be taken to include, but not be limited to, solid-state memories, optical and magnetic medium, and carrier wave signals.

Note that as an example, any “ports,” “combiners,” “splitters,” and other “circuits” mentioned in this description may be implemented using Field Programmable Logic Array(s) (FPGA(s)) and/or a digital signal processor(s) (DSP(s)), and therefore, may be embedded within the FPGA or be performed by computational processes.

The embodiments disclosed herein include various steps. The steps of the embodiments disclosed herein may be performed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes a machine-readable storage medium (e.g., read only memory (“ROM”), random access memory (“RAM”), magnetic disk storage medium, optical storage medium, flash memory devices, etc.).

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A controller may be a processor. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

We claim:

1. A reconfigurable intelligent surface (RIS) circuit, comprising:
an RIS array configured to absorb an incoming electromagnetic wave radiated from a radio node and reradiate an outgoing electromagnetic wave toward a user equipment (UE), the RIS array comprises:
a plurality of unit cell column circuits each comprising a plurality of vertical unit cells, each of the plurality of vertical unit cells comprises a respective one of a plurality of non-uniform patches having different geometric dimensions predetermined to cause a uniform phase differential between each adjacent pair of the plurality of vertical unit cells;
a plurality of unit cell row circuits each comprising a plurality of horizontal unit cells, each of the plurality of horizontal unit cells in a respective one of the plurality of unit cell row circuits comprises a respective one of a plurality of uniform patches of an identical geometric dimension; and
a plurality of control lines each coupled to the plurality of non-uniform patches in a respective one of the plurality of unit cell column circuits.

2. The RIS circuit of claim 1, further comprising a plurality of control circuits each coupled to a respective one of the plurality of control lines, the plurality of control circuits is configured to:
determine a plurality of phases that collectively control an azimuth angle of the outgoing electromagnetic wave;
generate a plurality of control signals each comprising a respective one of the plurality of phases; and
provide the plurality of control signals to the plurality of control lines, respectively.

3. The RIS circuit of claim 2, wherein each of the plurality of phases is expressed as (ΔΨ_{Y-RIS} [i]+360k+β) (1≤i≤N), wherein:
ΔΨ_{Y-RIS} represents the uniform phase differential;
k represents an integer value (0, 1, . . . ); and
β represents a phase constant.

4. The RIS circuit of claim 2, where each of the plurality of control lines is configured to relay a respective one of the plurality of control signals to each of the plurality of non-uniform patches in a respective one of the plurality of unit cell column circuits.

5. The RIS circuit of claim 1, wherein the different geometric dimensions are predetermined in accordance with a restricted set of incoming elevation angles associated with the incoming electromagnetic wave and a restricted set of outgoing elevation angles associated with the outgoing electromagnetic wave.

6. The RIS circuit of claim 5, wherein each of the restricted set of incoming elevation angles is within a lower boundary expressed as (φ_{RADIATION}−½HPBW) and an upper boundary expressed as (φ_{RADIATION}+½HPBW), wherein:
φ_{RADIATION} represents an elevation angle of the incoming electromagnetic wave relative to a local horizon of the radio node; and
HPBW represents a half power beamwidth of the incoming electromagnetic wave.

7. The RIS circuit of claim 5, wherein the uniform phase differential between each adjacent pair of the plurality of vertical unit cells in each of the plurality of unit cell column circuits is expressed as:
$$Δ {Ψ}_{Y - RIS} = - ( 2 π / λ ) * p * sin ( {ϕ}_{OUTGOING} ) - ( 2 π / λ ) * p * sin ( {ϕ}_{INCOMING} ) ,$$
ΔΨ_{Y-RIS} represents the uniform phase differential;
φ_{INCOMING} represents any of the restricted set of incoming elevation angles;
φ_{OUTGOING} represents any of the restricted set of outgoing elevation angles; and
p represents a maximum area of the plurality of vertical unit cells in each of the plurality of unit cell column circuits and the plurality of horizontal unit cells in each of the plurality of unit cell row circuits.

8. The RIS circuit of claim 1, wherein a vertical distance between the RIS array and the UE is less than or equal to a vertical distance between the RIS array and the radio node.

9. The RIS circuit of claim 8, wherein a horizontal distance between the RIS array and the radio node and a horizontal distance between the RIS array and the UE are both less than or equal to a coverage radius of the radio node.

10. A method for configuring a reconfigurable intelligent surface (RIS) circuit in a wireless communications system (WCS), comprising:
configuring an RIS array to absorb an incoming electromagnetic wave radiated from a radio node and reradiate an outgoing electromagnetic wave toward a user equipment (UE);
configuring a plurality of unit cell column circuits in the RIS array to each comprise a plurality of vertical unit cells, each of the plurality of vertical unit cells comprises a respective one of a plurality of non-uniform patches having different geometric dimensions predetermined to cause a uniform phase differential between each adjacent pair of the plurality of vertical unit cells;
configuring a plurality of unit cell row circuits in the RIS array to each comprise a plurality of horizontal unit cells, each of the plurality of horizontal unit cells in a respective one of the plurality of unit cell row circuits comprises a respective one of a plurality of uniform patches of an identical geometric dimension; and
providing a plurality of control lines in the RIS array to each be coupled to the plurality of non-uniform patches in a respective one of the plurality of unit cell column circuits.

11. The method of claim 10, further comprising:
determining a plurality of phases that collectively control an azimuth angle of the outgoing electromagnetic wave;
generating a plurality of control signals each comprising a respective one of the plurality of phases; and
providing the plurality of control signals to the plurality of control lines, respectively.

12. The method of claim 11, further comprising expressing each of the plurality of phases as (ΔΨ_{Y-RIS}[i]+360k+β) (1≤i≤N), wherein:
ΔΨ_{Y-RIS} represents the uniform phase differential;
k represents an integer value (0, 1, . . . ); and
β represents a phase constant.

13. The method of claim 11, further comprising each of the plurality of control lines relaying a respective one of the plurality of control signals to each of the plurality of non-uniform patches in a respective one of the plurality of unit cell column circuits.

14. The method of claim 10, further comprising predetermining the different geometric dimensions in accordance with a restricted set of incoming elevation angles associated with the incoming electromagnetic wave and a restricted set of outgoing elevation angles associated with the outgoing electromagnetic wave.

15. The method of claim 14, further comprising determining each of the restricted set of incoming elevation angles to be within a lower boundary expressed as (φ_{RADIATION}−½HPBW) and an upper boundary expressed as (φ_{RADIATION}+½HPBW), wherein:
φ_{RADIATION} represents an elevation angle of the incoming electromagnetic wave relative to a local horizon of the radio node; and
HPBW represents a half power beamwidth of the incoming electromagnetic wave.

16. The method of claim 14, further comprising expressing the uniform phase differential between each adjacent pair of the plurality of vertical unit cells in each of the plurality of unit cell column circuits as:
$$Δ {Ψ}_{Y - RIS} = - ( 2 π / λ ) * p * sin ( {ϕ}_{OUTGOING} ) - ( 2 π / λ ) * p * sin ( {ϕ}_{INCOMING} ) ,$$
ΔΨ_{Y-RIS} represents the uniform phase differential;
φ_{INCOMING} represents any of the restricted set of incoming elevation angles;
φ_{OUTGOING} represents any of the restricted set of outgoing elevation angles; and
p represents a maximum area of the plurality of vertical unit cells in each of the plurality of unit cell column circuits and the plurality of horizontal unit cells in each of the plurality of unit cell row circuits.

17. The method of claim 10, further comprising ensuring that a vertical distance between the RIS array and the UE is less than or equal to a vertical distance between the RIS array and the radio node.

18. The method of claim 17, further comprising ensuring that a horizontal distance between the RIS array and the radio node and a horizontal distance between the RIS array and the UE are both less than or equal to a coverage radius of the radio node.

19. A wireless communications system (WCS), comprising:
a distribution unit configured to distribute a plurality of data signals;
at least one radio node coupled to the distribution unit and configured to communicate with at least one user equipment (UE) in a respective coverage area; and
at least one reconfigurable intelligent surface (RIS) circuit provided in the respective coverage area, the at least one RIS circuit comprises an RIS array configured to absorb an incoming electromagnetic wave radiated from the at least one radio node and reflect an outgoing electromagnetic wave toward the at least one UE, the RIS array comprises:
a plurality of unit cell column circuits each comprising a plurality of vertical unit cells, each of the plurality of vertical unit cells comprises a respective one of a plurality of non-uniform patches having different geometric dimensions predetermined to cause a uniform phase differential between each adjacent pair of the plurality of vertical unit cells;
a plurality of unit cell row circuits each comprising a plurality of horizontal unit cells, each of the plurality of horizontal unit cells in a respective one of the plurality of unit cell row circuits comprises a respective one of a plurality of uniform patches of an identical geometric dimension; and
a plurality of control lines each coupled to the plurality of non-uniform patches in a respective one of the plurality of unit cell column circuits.

20. The WCS of claim 19, wherein RIS circuit further comprises a plurality of control circuits each coupled to a respective one of the plurality of control lines, the plurality of control circuits is configured to:
determine a plurality of phases that collectively control an azimuth angle of the outgoing electromagnetic wave;
generate a plurality of control signals each comprising a respective one of the plurality of phases; and
provide the plurality of control signals to the plurality of control lines, respectively.
